(19) United States
(12) Patent Application Publication
(10) Pub. No.: US 2002/0081062 A1
(43) Pub. Date: Jun. 27, 2002

(54) Optical grating based multi-input demultiplexer for multiple sets of interleaved wavelength channels

(76) Inventor: Jian-Jun He, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 09/801,903

(22) Filed: Mar. 9, 2001

Related U.S. Application Data
(60) Provisional application No. 60/257,050, filed on Dec. 22, 2000.

(51) Int. Cl. G02B 6/293

(52) U.S. Cl. 385/24; 385/37; 359/130

(57) ABSTRACT

An optical device for demultiplexing a plurality of interleaved sets of wavelength channels is described. The device supports at least two input ports in which each input port receives a plurality of optical channels corresponding to the normal output of an optical frequency interleaver. These signals are separated by the device in dependence of wavelength. This device, being bidirectional will also operate as a multiplexer.

### FIELD OF THE INVENTION

The invention relates generally to optical multiplexing and more particularly to employment of a single wavelength-dispersive element for multiplexing or demultiplexing multiple sets of interleaved wavelength channels.

### BACKGROUND OF THE INVENTION

The use of computers in networks has lead to a tremendous increase in the need for high capacity bandwidth optical networks. Fiber optics allows much faster data transmission than electrical systems they have replaced. One of the ways of boosting the total bandwidth of an optical network is with wavelength division multiplexing or WDM. This technology allows many different wavelength channels, each with it's own signal to use the same fiber. As the need for bandwidth increases the designers of the WDM components try to add more support for more channels to their products. As more and more channels are added it becomes harder to separate them. If they are not properly separated then they begin to inadvertently share signals. Also, as the number of channels increases the components that are needed to separate the individual channels becomes more complex and difficult to build. The function of a demultiplexer is demonstrated in FIG. 1. This difficulty in making high quality optical multiplexer or demultiplexer components has resulted in combining components to enhance the overall performance.

For example, it is known to those skilled in the art that producing a 200 GHz channel spaced demultiplexer is easier than producing a 100 GHz device. Similarly, a 100 GHz device is easier to produce than a 50 GHz device. U.S. Pat. No. 5,680,490, issued to Cohen et al. in 1997, describes a comb splitting system that uses a plurality of demultiplexers of a large channel spacing in conjunction with an optical interleaver to demultiplex wavelength channels of a smaller spacing. For example, by combining a pair of 200 GHz devices with twenty channels each and an appropriate interleaver, forty wavelength channels with 100 GHz spacing can be demultiplexed. This combination of components is shown in FIG. 2. Similarly, two 100 GHz forty channel devices or four 200 GHz twenty channel devices can be combined with an interleaver to produce a 50 GHz device with eighty channels. This technology is very beneficial because it makes building the individual components much easier. However it is apparent that building a device this way requires a large number of components. Further, the individual demultiplexers must have equally spaced and precisely interleaved channels, which presents a manufacturing problem. The reason for the problem is that different demultiplexers behave slightly differently. A paired device must be selected very carefully from a production lot, and their operating conditions must be individually tuned to achieve a good matching. The production yield is typically very low.

Different wavelength multiplexing and demultiplexing technologies are known, including: thin film filters, fiber Bragg gratings, phased arrayed waveguide gratings (AWG) and etched echelle grating-on-a-chip spectrometers. The integrated devices, including AWG and echelle grating, have many advantages such as compactness, reliability, reduced fabrication and packaging costs, and potential monolithic integration with active devices of different functionalities. However, it is generally recognized at present that thin film filters and fiber Bragg grating based demultiplexers are more suitable for low channel count devices, while AWG and echelle grating based waveguide demultiplexers are better suited for large channel count devices.

For many network applications, especially for metropolitan networks, it is desirable that the system be scalable, for instance a small number of channels are added/dropped at a node initially but that number may be increased at a later time together with the total number of channels in the system, as demand on the network increases. This puts integrated devices such as AWG and echelle grating in less favourable position for this type of applications due to the small channel count. By using the channel interleaving scheme, the number of channels on individual demultiplexers is further reduced.

Between the two waveguide based technologies AWG and echelle grating, the echelle grating require high quality, deeply etched grating facets. The optical loss of the device depends critically on the verticality and smoothness of the grating facets. However, the size of the grating device is much smaller than the phased waveguide array and the spectral finesse is much higher due to the fact that the number of teeth in the grating is much larger than the number of waveguides in the phased array. The crosstalk is also lower due to the fact that it is easier to reduce the phase errors in a small grating. With the recent advancement in etching technology, the echelle grating has become a promising alternative to AWG device.

It would be advantageous to provide a waveguide grating based apparatus for multiplexing or demultiplexing multiple sets of interleaved wavelength channels simultaneously using a same dispersive element.

It would be further advantageous to provide an echelle grating based device that performs multiplexing/demultiplexing for multiple sets of wavelength channels simultaneously. In additional to the advantages inherently associated with echelle gratings, all input and output ports of the device can be coupled to a single fiber array on one side of the chip, thus reducing the packaging costs.

### Object of the Invention

It is an object of the invention to provide a waveguide grating based apparatus for multiplexing/demultiplexing multiple sets of interleaved wavelength channels simultaneously.

In particular, it is an object of the invention to provide an echelle grating based multiplexer-demultiplexer of which the input and output ports are appropriately arranged so that the blazing angles of the grating facets are optimized simultaneously for the different sets of wavelength channels.

### SUMMARY OF THE INVENTION

In accordance with the invention there is provided an optical multiplexing-demultiplexing device comprising:

a wavelength dispersive element;

a first input port optically coupled to the wavelength dispersive element for receiving first optical signals corresponding to a set of optical channels having consistent known wavelength channel spacing at first wavelengths;

a second input port optically coupled to the wavelength dispersive element for receiving a second optical signals corresponding to a set of optical wavelength channels having the same consistent wavelength spacing at wavelengths offset from the first wavelengths wherein the offset is a non-zero fraction of the channel spacing;

a first plurality of optical output ports optically coupled to the wavelength dispersive element for providing optical signals corresponding to the individual channels associated with the first input port; and,

a second plurality of optical output ports optically coupled to the wavelength dispersive element for providing optical signals corresponding to the individual channels of the second optical input port.

In accordance with the invention there is further provided an optical wavelength division multiplexer/demultiplexer device comprising:

an input port 21a for coupling a first multiplexed optical signal containing a first plurality of wavelength channels with a predetermined channel spacing from an optical fiber to an input waveguide 22a;

a plurality of output ports 24a1 to 24aN, each for coupling a channelized signal of said first plurality of wavelength channels from a single corresponding waveguide 23al to 23aN to an optical fiber;

an input port 21b for coupling a second multiplexed optical signal containing a second plurality of wavelength channels with a same predetermined channel spacing but interleaved with the first individual wavelength channels from an optical fiber to an input waveguide 22b; a plurality of output ports 24b1 to 24bN, each for coupling a channelized signal of said second plurality of wavelength channels from a single corresponding waveguide 23b1 to 23bN to an optical fiber; and,

an echelle grating element 26 disposed for separating the first multiplexed optical signal received from the input waveguide 22a into signals within first individual wavelength channels and for directing each into a corresponding output waveguide 23a1 to 23aN and for separating a second multiplexed optical signal received from the input waveguide 21b into signals within second individual wavelength channels and for providing the signals to corresponding output waveguides 23b1 to 23bN.

In accordance with the invention there is also provided an optical multiplexing-demultiplexing device comprising:

a wavelength dispersive element;

a plurality of input ports optically coupled to the wavelength dispersive element each for receiving a multiplexed plurality of optical signals corresponding to a set of optical channels having a consistent known wavelength channel spacing and having a wavelength offset between different sets of the optical channels wherein the offset is a non-zero fraction of the channel spacing;

a plurality of output port arrays optically coupled to the wavelength dispersive element each having a plurality of output ports for providing optical signals corresponding to the individual channels associated with each of the input ports.

Such a device reduces the number of devices required in an interleaved wavelength demultiplexing system while increasing the number of channels on the single grating device, thus making the waveguide grating based technology more efficient and economically more competitive, even for the small channel count market. Moreover, since the same grating device performs the multiplexing/demultiplexing of all channels, the wavelengths of the different channel sets are automatically matched between each other.

### BRIEF DESCRIPTION OF THE DRAWINGS

The invention will now be described with reference to the drawings in which:

FIG. 1 is a schematic of a prior art demultiplexer

FIG. 2 is a schematic of a prior art demulitiplexer with an interleaver and two demultiplexers

FIG. 3 is a schematic of a proposed demultiplexer according to one embodiment of the invention.

FIG. 4 is a schematic diagram of an echelle grating based dual-input demultiplexer for two sets of interleaved wavelength channels according to a first preferred embodiment of the invention.

FIG. 5 is a schematic diagram showing the grating facet blazing angle design in relation to the channel waveguide endpoint arrangement according to the first preferred embodiment of the invention.

FIG. 6 is a schematic diagram of an AWG based dual-input demultiplexer for two sets of interleaved wavelength channels according to a second embodiment of the invention.

FIG. 7 is a schematic diagram of an AWG based dual-input demultiplexer for two sets of interleaved wavelength channels according to a third embodiment of the invention.

FIG. 8 is a schematic diagram of a M-input demultiplexer for demultiplexing M sets of interleaved wavelength channels according to a fourth embodiment of the invention.

### DETAILED DESCRIPTION OF THE INVENTION

The invention provides a demultiplexing method and apparatus for achieving high channel density capability by combining a single wavelength dispersive element with comparatively lower channel density capability and an interleaver. Since only one wavelength dispersive element is present the spacing of the individual channels is very consistent.

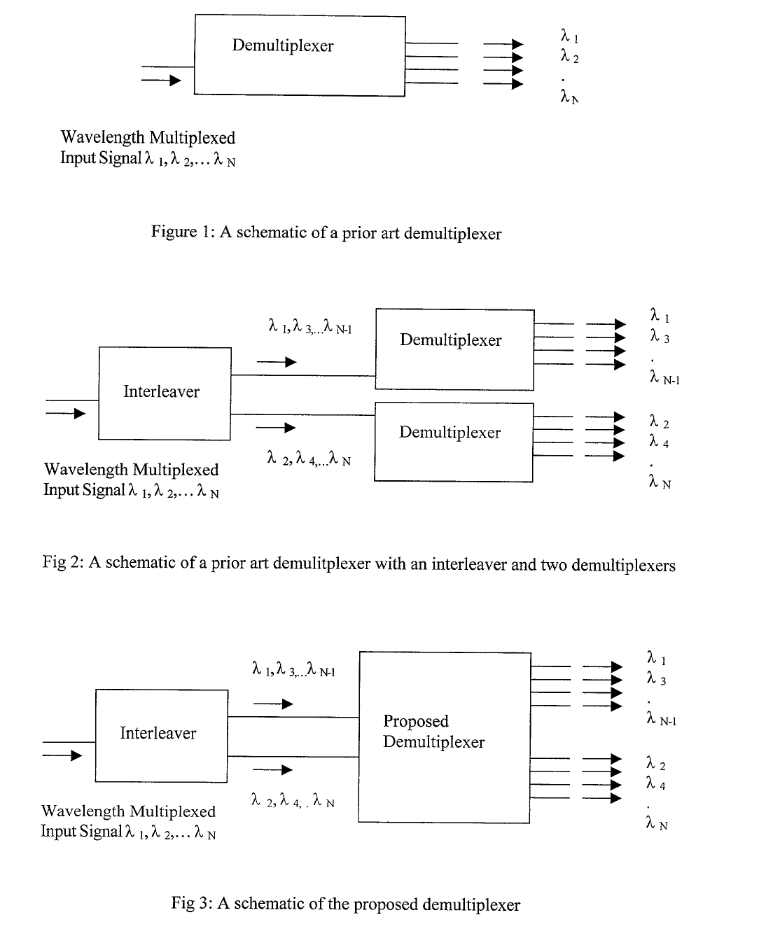

Referring to FIG. 1, a conventional wavelength demultiplexer according to the prior art is shown. The device receives a plurality of wavelength channels, and separates them into individual channels in dependence of wavelength. The demultiplexer may consist of an arrayed waveguide grating (AWG) or an echelle grating based device.

FIG. 2 shows another prior art device in which two demultiplexers of a large channel spacing are used in conjunction with an optical interleaver to demultiplex wavelength channels of half of the spacing. The advantage of this method is that it makes building the individual demultiplexers much easier because of the large channel spacing. However it is apparent that building a device this way requires a large number of components. Further, the individual demultiplexers must have equally spaced and precisely interleaved channels. A paired device must be selected very carefully from a production lot, and their operating conditions (e.g. the temperature) must be individually tuned to achieve a good matching. It is also important that their properties not change with time or changing environmental conditions.

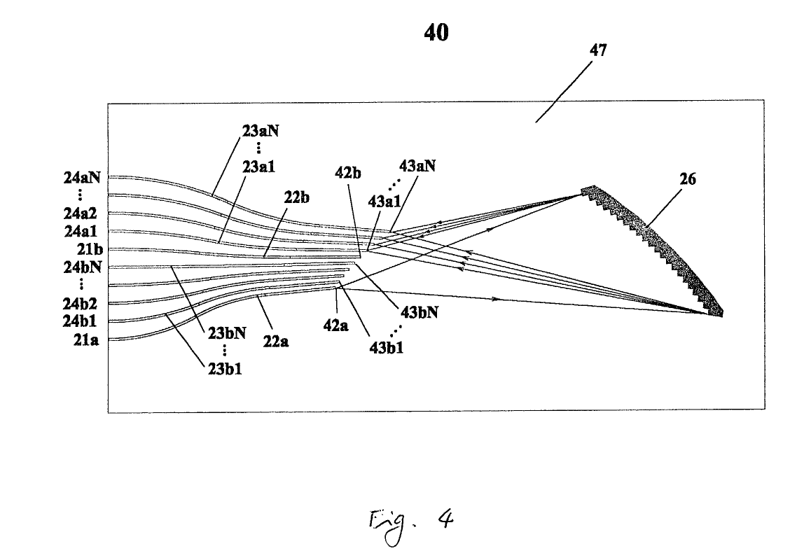

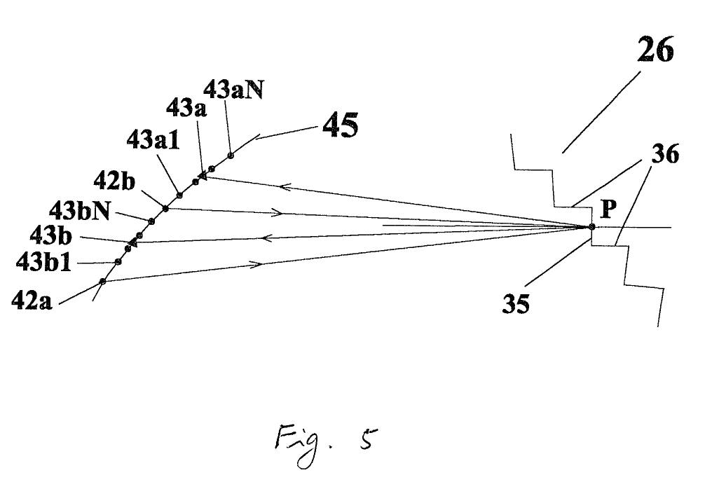

FIG. 3 shows a schematic diagram of a demultiplexer according to the present invention. The two demultiplexers are integrated on the same chip and packaged in the same module. This not only significantly reduces the cost, but also removes problems of channel wavelength mismatch due to fabrication errors and temperature instabilities associated with prior art conventional devices using separate demultiplexer modules.

With reference to FIG. 4, a demultiplexer employing a same dispersive element for demultiplexing two sets of interleaved wavelength channels according to a first preferred embodiment of the current invention is shown generally at 40. The device comprises a first input port 21a for coupling a first multiplexed optical signal containing a first plurality of wavelength channels with a predetermined channel spacing Δ from an optical fiber to an input waveguide 22a; a second input port 21b for coupling a second multiplexed optical signal containing a second plurality of wavelength channels with the same predetermined channel spacing Δ but interleaved with the first individual wavelength channels from an optical fiber to an input waveguide 22b; a first plurality of output ports 24a1 to 24aN, each for coupling a channelized signal of said first plurality of wavelength channels from a single corresponding waveguide 23a1 to 23aN to an optical fiber; a second plurality of output ports 24b1 to 24bN, each for coupling a single wavelength signal of said second plurality of wavelength channels from a single corresponding waveguide 23b1 to 23bN to an optical fiber; and an echelle grating element 26 disposed for separating said first and second multiplexed optical signals received from the input waveguide 22a and 22b into individual wavelength channels each coupled into a corresponding output waveguide 23a1 to 23aN and 23b1 to 23bN. As will be apparent to those skilled in the art, all of these components are preferably formed on a single substrate 47.

The demultiplexing operation of the device for the first multiplexed optical signal is shown in FIG. 4. The multiplexed optical signal propagating along channel waveguide 22a to a region defining a slab waveguide. The multiplexed signals fan out from the waveguide end point 42a into the slab waveguide region and propagate through said slab waveguide to a dispersive element 26. The grating 26 is positioned along the slab waveguide and is structured to intercept the optical signal propagating within the slab waveguide and to diffract it into components of different wavelength angularly dispersed with respect to one another so that at a predetermined distance from the grating 26 said components of the first signal are spatially separated at locations 43al to 43aN corresponding to those of an input surface of one of a plurality of channel waveguides 23a1 to 23aN, each channel waveguide in optical communication with one port of the plurality of ports 24a1 to 24aN.

The demultiplexing operation of the device for the second multiplexed optical signal is similar. However, the position of the input waveguide endpoint 42b in relation to the positions of input endpoints 43b1 to 43bN of the output waveguides 24b1 to 24bN is adjusted so that the channel wavelengths of the second plurality of wavelength channels are displaced by half channel spacing with respect to the first plurality of wavelength channels. In one particular embodiment, the distance between the two input waveguide ends 42a and 42b is different than the distance between the two output waveguide ends 43a1 and 43b1, with the difference corresponding to half of the channel spacing Δ.

According to a preferred embodiment of the invention, the dispersive element 26 is a reflection type echelle grating formed with focusing as well as dispersion properties. Alternatively, other types of dispersive elements, for instance a transmissive arrayed waveguide grating, are functionally similar. However, the reflection-type echelle grating has advantages over arrayed waveguide gratings because it is smaller in size and the input and output ports of the device can be coupled to a single fiber array on one side of the chip, thus reducing the packaging costs.

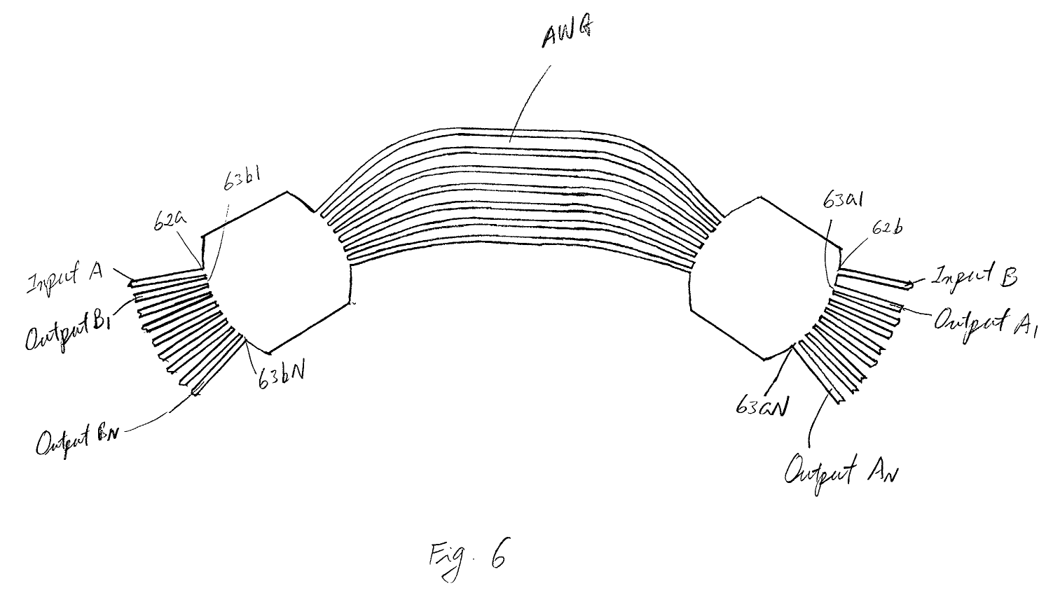

According to a preferred embodiment of the invention, the positions of the endpoints 42a, 42b, 43a1 to 43aN, and 43b1 to 43bN of the input and output waveguides are arranged so that the reflecting facets of the echelle grating are optimally blazed simultaneously for both demultiplexers, thus minimizing the insertion loss for both devices. FIG. 5 shows the schematic of the arrangement. For a grating facet 35 centered at point P, the normal to the facet divides substantially equally the angle formed by the waveguide endpoint 42a, point P and point 43a, which is the middle point between 43a1 and 43aN. At the same time, it also divides substantially equally the angle formed by the waveguide endpoint 42b, point P and point 43b, which is the middle point between 43b1 and 43bN.

According to a preferred embodiment of the invention that substantially satisfies above criteria, the endpoints 42a, 42b, 43a1 to 43aN, and 43b1 to 43bN of the input and output waveguides are located along a curved or straight line 45 in the order of 42a, 43b1 to 43bN, 42b, and 43a1 to 43aN. This allows the separation between any two adjacent end points to be substantially equal to the spatial dispersion generated by the grating for two wavelengths separated by a channel spacing in the wavelength domain, except for the distance between the input waveguide endpoint 42a and the adjacent output waveguide endpoint 43b1 which is substantially equal to 1.5 times the channel spacing. The total spreading of the endpoints along the line 45, and consequently the aberration effect of the grating are minimized. The device transmission loss caused by shadowing effect of side walls 36 is also minimized. To avoid waveguide crossings, the input and output ports are arranged in the same order, i.e., 21a, 24b1 to 24bN, 21b, and 24a1 to 24aN.

The demultiplexer according to the first embodiment of the invention has two input ports and is to be used in conjunction with an interleaver having an input port and two output ports. Each input port of the demultiplexer is optically coupled to an output port of the interleaver. The interleaver is then able to receive a set of wavelength signals of a channel spacing equal to half of that of the demultiplexer, i.e. Δ/2. For example, if the input to the interleaver is 40 channels spaced at 100 GHz, the interleaver separates the signal into two sets of 20 channel 200 GHz signals. The signals are then separated by the dual-input echelle grating demultiplexer, requiring 200 GHz channel spacing, which is generally much smaller than a single-input demultiplexer of 100 GHz spacing.

It is an advantage of the above embodiment that two sets of interleaved wavelength channels are demultiplexed simultaneously using a same dispersive element. Thus problems associated with mismatching performances of two optical devices are avoided. Such a device also reduces the number of devices required in an interleaved wavelength demultiplexing system while increasing the number of channels on the single grating device, thus making the waveguide grating based technology more efficient and economically more competitive, even for the small channel count application. It is a further advantage of the first embodiment that the device is small compared to AWG based devices and that the input/output ports can be coupled to a single fiber array, thus reducing the packaging cost. The insertion loss of the device is minimized for both the demultiplexer and multiplexer for all channels due to the optimized grating blaze angle, according to the preferred embodiment of the invention.

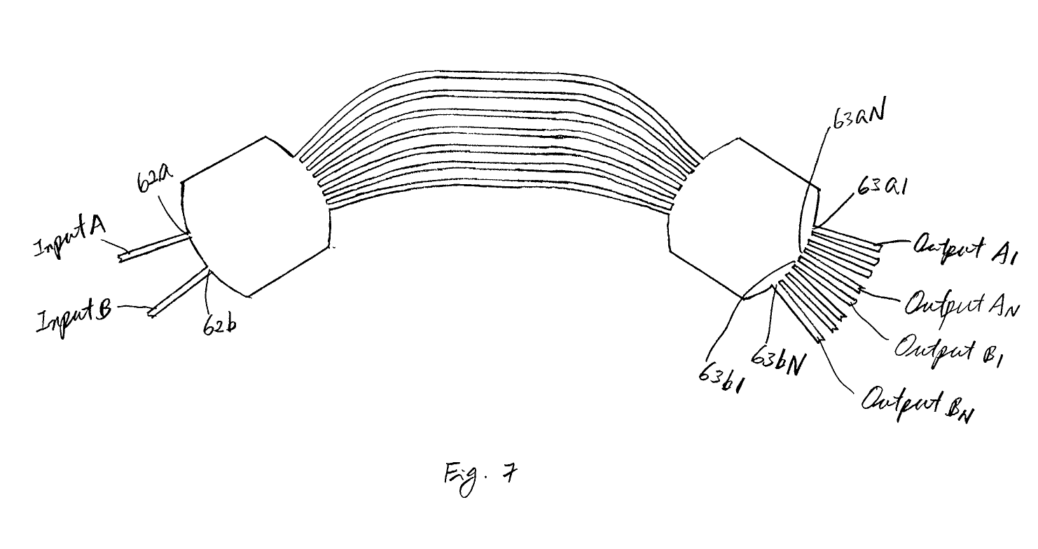

In FIG. 6, a schematic diagram of an AWG based dual-input demultiplexer for two sets of interleaved wavelength channels according to a second embodiment of the invention is shown. The device consists of two input ports A and B, one on each side of the AWG, each for receiving a plurality of wavelength channels with a channel spacing Δ. The two sets of the wavelength channels are interleaved, i.e. the channel wavelengths are shifted by Δ/2 with respect to each other. The output ports A₁ to A_{N} and B₁ to B_{N} are located on the opposite side of the AWG with respect to the corresponding input port. In one particular embodiment of the invention, the waveguide ends 63a1 to 63aN of the output ports A₁ to A_{N} and the waveguide ends 63b1 to 63bN of the output ports B₁ to B_{N} are substantially symmetric with respect to the AWG. However, the waveguide end 62a of the input A and the waveguide end 62b of the input B are not symmetric. The distance between 62a and the waveguide end 63b1 of the adjacent output port is different than that between 62b and 63a1, with the difference corresponding to half of the channel spacing Δ.

FIG. 7 is a schematic diagram of another AWG based dual-input demultiplexer for demultiplexing two sets of interleaved wavelength channels according to a third embodiment of the invention. The device consists of two input ports A and B on one side of the AWG, for receiving two interleaved sets of wavelength channels. The output ports A₁ to A_{N} and B₁ to B_{N} are located on the opposite side of the AWG. In one particular embodiment of the invention, the distance between the two input waveguide ends 62a and 62b is different than that between the two output waveguide ends 62a1 and 63b1, with the difference corresponding to half of the channel spacing Δ.

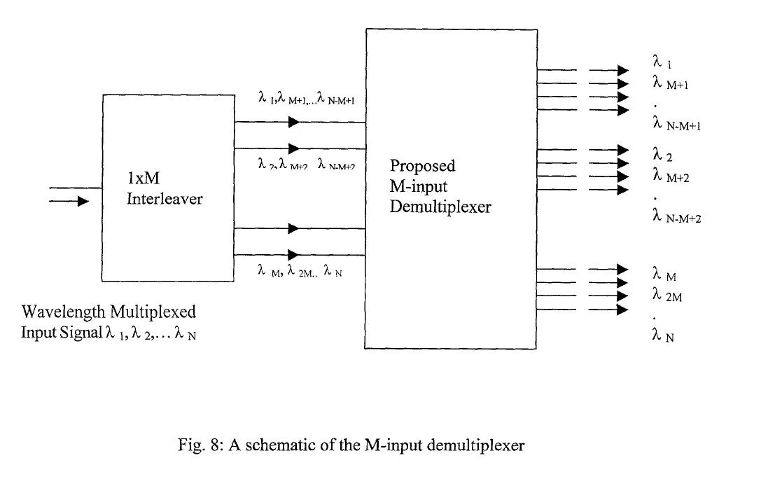

It is apparent to those skilled in the art that the principle of the above embodiments can be extended to other embodiments in which the demultiplexer has M input ports and M sets of output ports where M is greater than 2. FIG. 8 is a schematic diagram of a M-input demultiplexer for demultiplexing M sets of interleaved wavelength channels according to a fourth embodiment of the invention. It can be implemented using either an echelle grating or an AWG.

It is also apparent that the devices according to above embodiments are bi-directional, allowing them to be used as a multiplexer or demultiplexer or both simultaneously.

Numerous other modifications and alternative embodiments can be made without departing substantially from the teachings or scope of the invention.

What is claimed is:

1. An optical multiplexing-demultiplexing device comprising:
a wavelength dispersive element;
a first input port optically coupled to the wavelength dispersive element for receiving first optical signals corresponding to a set of optical channels having consistent known wavelength channel spacing at first wavelengths;
a second input port optically coupled to the wavelength dispersive element for receiving a second optical signals corresponding to a set of optical wavelength channels having the same consistent wavelength spacing at wavelengths offset from the first wavelengths wherein the offset is a non-zero fraction of the channel spacing;
a first plurality of optical output ports optically coupled to the wavelength dispersive element for providing optical signals corresponding to the individual channels associated with the first input port; and,
a second plurality of optical output ports optically coupled to the wavelength dispersive element for providing optical signals corresponding to the individual channels of the second optical input port.

2. An optical multiplexing-demultiplexing device according to claim 1 wherein the fraction is approximately ½.

3. An optical multiplexing-demultiplexing device according to claim 1 comprising: an interleaver having
an interleaver optical input port;
a first interleaver optical output port; and,
a second interleaver output port,
the first interleaver output port for providing a set of optical wavelength channels corresponding to the channels of the first optical input port and coupled to said first optical input port, and the second interleaver output port for providing a set of optical wavelength channels corresponding to the channels of the second optical input port and coupled to said second optical input port.

4. The device as recited in claim 3 comprising a substrate having integrally formed therein the input ports, the output ports and the wavelength dispersive element.

5. The device as recited in claim 4 comprising at least one region disposed between the input ports and the output ports, said at least one region defining a slab waveguide along which, when in use, the signals propagate.

6. The device as recited in claim 5 wherein the substrate is made of a material selected from the group consisting of: InP, GaAs, SiO₂ and Si.

7. The device as recited in claim 5 wherein the wavelength dispersive element is positioned along the slab waveguide and is structured to intercept the first and second optical signals propagating within the slab waveguide and to diffract said first and second optical signals into component signals of different wavelength angularly dispersed with respect to one another so that at a predetermined distance from the wavelength dispersive element each component signal is approximately channelized, each channelized component signal of the first optical signals guided to one of the first plurality of output ports associated with the first input port and each channelized component signal of the second optical signals guided to one of the second plurality of output ports associated with the second input port.

8. The device as recited in claim 1 wherein the dispersive element is an array waveguide grating.

9. The device as recited in claim 8 wherein the first and second input ports are located on the same side of the array waveguide grating.

10. The device as recited in claim 9 wherein the distance between the opposing ends of the waveguides optically coupled with the two input ports is different than the distance between the opposing ends of the waveguides optically coupled with the two output ports corresponding to the same channel number within each of the first and second plurality of output ports, with the difference substantially corresponding to half of the channel spacing.

11. The device as recited in claim 8 wherein the first and second input ports are located on the opposite sides of the array waveguide grating and the first and second pluralities of the output ports are located on the opposite side of the AWG with respect to the corresponding input port.

12. The device as recited in claim 11 wherein the distance between the opposing end of the waveguide optically coupled with the first input port and the opposing end of the waveguide optically coupled with the adjacent output port is different than the distance between the opposing end of the waveguide optically coupled with the second input port and the opposing end of the waveguide optically coupled with the adjacent output port, with the difference substantially corresponding to half of the channel spacing.

13. The device as recited in claim 1 wherein the dispersive element is an echelle grating.

14. The device as recited in claim 13 wherein the distance between the opposing ends of the waveguides optically coupled with the two input ports is different than that between the opposing ends of the waveguides optically coupled with the two output ports corresponding to the same channel number within each of the first and second plurality of output ports, with the difference substantially corresponding to half of the said predetermined channel spacing.

15. The device as recited in claim 14 wherein each of the first and second input ports and the first and second plurality of output ports are optically coupled with waveguides having an opposing end positions which are arranged so that reflective facets of the echelle grating are blazed simultaneously for all channels.

16. The device as recited in claim 15 wherein for a grating facet centered at a point P, a normal to the facet divides substantially equally an angle formed between the opposing endpoint of the waveguide optically coupled with the first input port, P, and a middle point between the opposing ends of the waveguides optically coupled with the first plurality of output ports, and a normal to the facet divides substantially equally an angle formed between the opposing endpoint of the waveguide optically coupled with the second input port, P, and a middle point between the opposing ends of the waveguides optically coupled with the second plurality of output ports.

17. An optical wavelength division multiplexer/demultiplexer device comprising:
an input port 21a for coupling a first multiplexed optical signal containing a first plurality of wavelength channels with a predetermined channel spacing from an optical fiber to an input waveguide 22a;
a plurality of output ports 24a1 to 24aN, each for coupling a channelized signal of said first plurality of wavelength channels from a single corresponding waveguide 23a1 to 23aN to an optical fiber;
an input port 21b for coupling a second multiplexed optical signal containing a second plurality of wavelength channels with a same predetermined channel spacing but interleaved with the first individual wavelength channels from an optical fiber to an input waveguide 22b;
a plurality of output ports 24b1 to 24bN, each for coupling a channelized signal of said second plurality of wavelength channels from a single corresponding waveguide 23b1 to 23bN to an optical fiber; and,
an echelle grating element 26 disposed for separating the first multiplexed optical signal received from the input waveguide 22a into signals within first individual wavelength channels and for directing each into a corresponding output waveguide 23a1 to 23aN and for separating a second multiplexed optical signal received from the input waveguide 21b into signals within second individual wavelength channels and for providing the signals to corresponding output waveguides 23b1 to 23bN.

18. The device as recited in claim 17 wherein the echelle grating and the input and output ports are disposed such that the wavelengths of said second plurality of wavelength channels are substantially between those of said first plurality of wavelength channels.

19. The device as recited in claim 18 wherein the distance between the opposing ends of the waveguides optically coupled with the two input ports 21a to 21b is different than that between the opposing ends of the waveguides optically coupled with the two output ports 24a1 and 24b1, with the difference substantially corresponding to half of the said predetermined channel spacing.

20. The device as recited in claim 17 wherein each of the input and output ports are optically coupled with a waveguide having opposing ends positions of which are arranged so that reflective facets of the echelle grating are approximately optimally blazed simultaneously for the light signals traveling from the input port 21a to output ports 24a1 to 24aN and from input port 21b to output ports 24b1 to 24bN.

21. The device as recited in claim 20 wherein for a grating facet centered at a point P, a normal to the facet divides substantially equally an angle formed between the opposing endpoint of the waveguide optically coupled with the input port 21a, P, and a middle point between the opposing ends of the waveguides optically coupled with the output ports 24a1 and 24aN, and said normal to the facet divides substantially equally an angle formed between the opposing endpoint of the waveguide optically coupled with the input port 21b, P, and a middle point between the opposing ends of the waveguides optically coupled with the output ports 24b1 and 24bN.

22. The device as recited in claim 21 comprising a substrate having integrally formed therein the input and output ports, and the echelle grating.

23. The device as recited in claim 22 wherein the substrate is made of a material selected from the group consisting of: InP, GaAs, SiO₂ and Si.

24. An optical multiplexing-demultiplexing device comprising:
a wavelength dispersive element;
a plurality of input ports optically coupled to the wavelength dispersive element each for receiving a multiplexed plurality of optical signals corresponding to a set of optical channels having a consistent known wavelength channel spacing and having a wavelength offset between different sets of the optical channels wherein the offset is a non-zero fraction of the channel spacing;
a plurality of output port arrays optically coupled to the wavelength dispersive element each having a plurality of output ports for providing optical signals corresponding to the individual channels associated with each of the input ports.

25. An optical multiplexing-demultiplexing device according to claim 24 wherein the fraction is approximately 1 divided by the number of input ports.

26. An optical multiplexing-demultiplexing device according to claim 24 comprising:
an interleaver having
an interleaver optical input port; and
a plurality of interleaver optical output ports;
each interleaver output port for providing a set of optical wavelength channels corresponding to the channels of an optical input port and coupled to said optical input port.

27. The device as recited in claim 24 wherein the dispersive element is an array waveguide grating.

28. The device as recited in claim 27 wherein the input ports are located on the same side of the array waveguide grating.

29. The device as recited in claim 27 wherein the input ports are located on the opposite sides of the array waveguide grating.

30. The device as recited in claim 24 wherein the dispersive element is an echelle grating.
